(19) United States
(12) Patent Application Publication
(10) Pub. No.: US 2012/0278271 A1
(43) Pub. Date: Nov. 1, 2012

(54) System and Method for Expanding Variables Associated a Computational Model

(75) Inventors: Bruce E. Peoples, State College, PA (US); Michael R. Johnson, State College, PA (US); Jonathon P. Smith, Port Matilda, PA (US); Bryan D. Glick, State College, PA (US); Robert J. Cole, Pa Furnace, PA (US)

(73) Assignee: RAYTHEON COMPANY, Waltham, MA (US)

(21) Appl. No.: 13/094,196

(22) Filed: Apr. 26, 2011

(51) Int. Cl. G06N 5/02

(52) U.S. Cl. 706/52

(57) ABSTRACT

Disclosed is a system and method for expanding variables within a computational model. The computational model, which can be a Bayesian-network, includes input and output variables that are interrelated via a conditional probability table. Term expansion is accomplished via a lexical database and a logic engine to determine semantic equivalents that are relevant to the computational model. The expanded terms allow the computational model to be related to instance data, which may be in the form of a dynamic ontology. Input variable expansion permits the computational model to be populated with semantically relevant instance data from the ontology, and output variable expansion permits the computational model to be associated with semantically relevant ontology nodes.

This disclosure relates to term expansion. More specifically, the disclosure relates to determining semantically equivalent terms for use within a computational model.

### BACKGROUND OF THE INVENTION

There are over 500 billion gigabytes of digital information in the world today. Starting in 2010, the total amount of digital information in existence will begin to increase exponentially. No one human is capable of reviewing this information, much less making sense of it. No matter the domain of interest, humans cannot be expected to find the nuggets of critical information in this sea of data, information, and knowledge. Complicating matters is that in today's information society, data, information, and knowledge are often distributed across vast computer networks.

As a result of this ever growing sea of data and the distribution thereof, there is a need for computer based information technology (“IT”) applications that can sift through huge amounts of digital data to find content that is current, relevant, and contextually appropriate. The goal of any such IT system is to assist a human user, or in some cases a digital agent representing a human user, in quickly discovering relevant data, information, and knowledge that would be impossible to discover by human effort alone due to the extremely large data sets, knowledge stores, and associated computer networks.

The need for processing large amounts of digital data is especially acute in the area of national security. We are faced today with increasing threats from adversaries around the world. The solemn task of protecting against future attacks rests with the world's intelligence agencies. Intelligence agencies are constantly investigating potential threats so that any adversarial activities can be timely thwarted. In doing so, agencies must process large volumes of information in order to uncover any hints, clues, or insights about potential attacks. These agencies need vastly improved IT systems so they can effectively and timely “connect the dots” and ensure that any opportunity to thwart a planned attack is not lost.

But the need to process large amounts of digital data is not exclusive to intelligence agencies. The need arises in a wide variety of fields. These fields include, for example, medicine and epidemiology. A large percentage of the information currently stored on today's computers relates to medical records. Health agencies have a continuing need for a more effective means to review and make sense of this information. The ability for health care workers to meaningfully review data on emerging diseases would help in anticipating future epidemics and pandemics. This, in turn, would lead to the timely production of vaccines.

Ultimately, there is a growing need in many different fields for improved IT systems that allow human users to systematically review large data sets or knowledge stores in order to obtain information that is relevant, timely, and contextually appropriate.

### SUMMARY OF THE INVENTION

The disclosure provides both a system and a method for expanding variables within a computational model. The computational model, which can be a Bayesian-network, includes input and output variables that are interrelated via a conditional probability table. Term expansion is accomplished via a lexical database and a logic engine to determine semantic equivalents that are relevant to the computational model. The expanded terms allow the computational model to be related to instance data, which may be in the form of a dynamic ontology. Input variable expansion permits the computational model to be populated with semantically relevant instance data from the ontology, and output variable expansion permits the computational model to be associated with semantically relevant ontology nodes.

The disclosed system has several important advantages. For example, the system permits term expansion to locate semantically equivalent and logically relevant terms.

The term expansion disclosed herein permits users to populate computational models with relevant instance data.

A further possible advantage is the ability to expand output terms within a computational model to allow the model to be linked with relevant nodes within a dynamic ontology.

Still yet another possible advantage is to create a system of term whereby expanded terms can be linked to associated computational models and variables.

The present system permits term expansion to be carried out systematically and without the need for a human operator.

Various embodiments of the invention may have none, some, or all of these advantages. Other technical advantages of the present invention will be readily apparent to one skilled in the art.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is an illustration of a computational model relating input variables to an output variable via a conditional probability table.

FIG. 2 is a diagram illustrating different ontological models interconnected by an event node.

FIG. 3 is a diagram illustrating one embodiment of the disclosed system, including a client, a server and a computer memory.

FIG. 4 is a diagram illustrating how the expansion of input variables permits the computational table to be populated by semantically relevant terms.

FIG. 5 is a diagram illustrating how the expansion of an output variable permits the computational table to be associated with semantically relevant event nodes.

FIG. 6 is a diagram illustrating the steps associated with the disclosed methods.

### DETAILED DESCRIPTION OF THE DRAWINGS

The present disclosure relates to a system and method for expanding variables within a computational model. The computational model, which can be a Bayesian-network, includes input and output variables that are interrelated via a conditional probability table. Term expansion is accomplished via a lexical database and a logic engine to determine semantic equivalents that are relevant to the computational model. The expanded terms allow the computational model to be related to instance data, which may be in the form of a dynamic ontology. Input variable expansion permits the computational model to be populated with semantically relevant instance data from the ontology, and output variable expansion permits the computational model to be associated with semantically relevant ontology nodes.

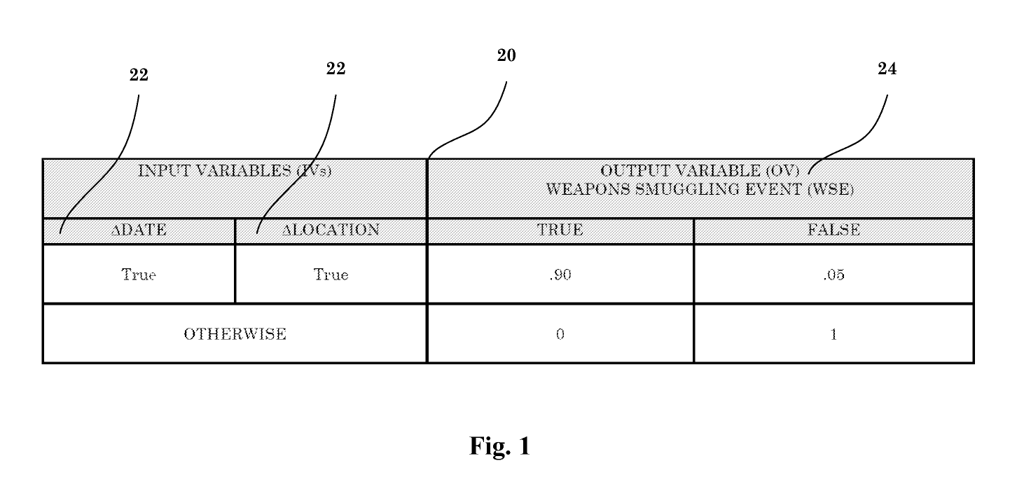

FIG. 1 is a diagram of a computational model 20 and associated input and output variables (22 and 24). In an illustrative but not limiting example, the computational model is a Bayesian-network (“B-net”) running on a server and residing in a computer memory. The computational model includes a conditional probability table (“CPT”) that specifies the existence of the output variable 24 based upon the input variables 22. The conditional probability table can, therefore, be used to specify the probability of a specific event occurring based on historical data or a prior statistical analysis. Each of the variables has one or more associated terms. Additionally, universal resource identifier (URI) data are associated with the Bayesian-network 20 and the input and output variables (22 and 24).

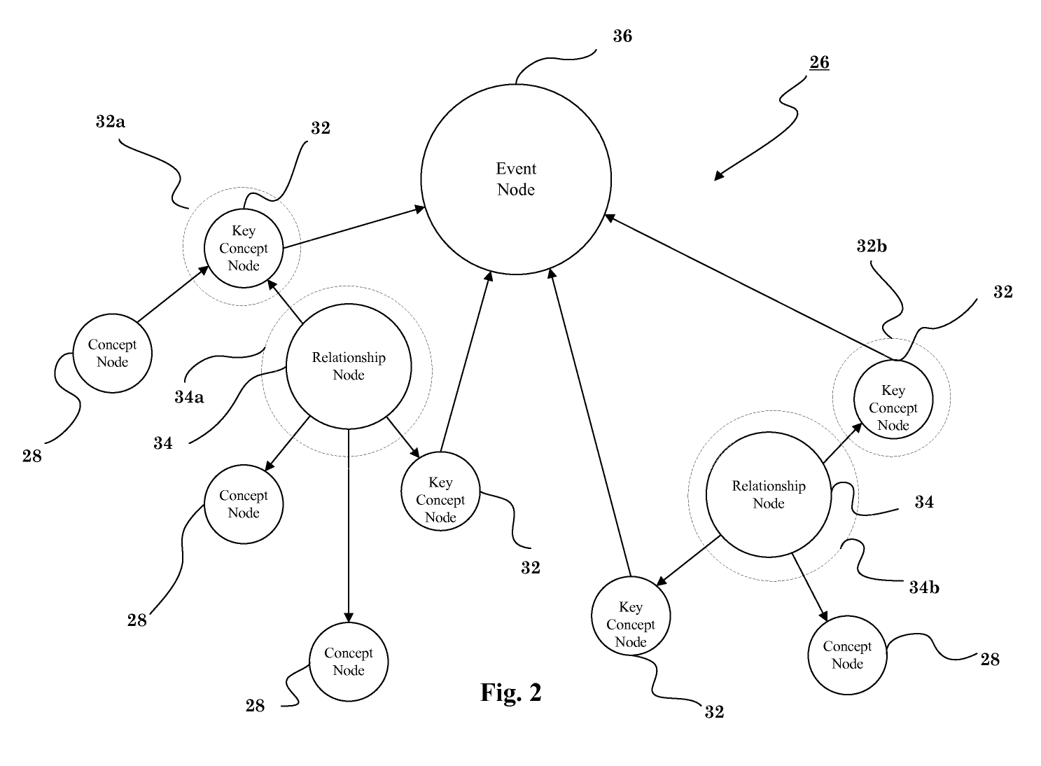

In the illustrated example, two input variables 22, “ΔDate” and “ΔLocation,” are related to a single output variable 24, “Weapons Smuggling Event.” The input variables 22 are related to other events by the CPT. In this example, the CPT specifies the probability of a Weapons Smuggling Event if a Militia Training Event and a Military Convoy Event occur (note FIG. 2) within a specified date range (“ΔDate”) and within a distance of each other (“ΔLocation”). The CPT specifies that if both date range and distance limitations are true, then there is a 90% chance of a Weapons Smuggling Event occurring and a 5% chance of a Weapons Smuggling Event not occurring. Otherwise, there is a 0% chance of the event occurring and a 100% chance of the event not occurring.

A more detailed discussion of this computational model 20 and the associated ontology is contained in co-pending and commonly owned U.S. patent application Ser. No. 12/748,514 filed on Mar. 29, 2010 and entitled “System and Method for Predicting Event Via Dynamic Ontologies.” The contents of this co-pending application are fully incorporated herein for all purposes.

The computational model 20 must be populated with instance data from actual events. This instance data can be collected over time and stored in a knowledge base or data center. In one non-limiting example, the instance data is formatted into a dynamic ontology 26, such as the ontology illustrated in FIG. 2. As illustrated, the ontology includes a number of interconnected nodes. The nodes can include Concept Nodes 28, Key Concept Nodes 32, and Relationship Nodes 34. Two or more ontologies can be interrelated via an Event Node 36. The ontologies 26 can be related to variables (22 and 24) within computational model 20. In the example above, the “ΔDate” and “ΔLocation” variables are represented respectively by key concept nodes 32a and 32b. Additionally, the “Militia Training Event” and “Military Convoy Event” are represented by Relationship Nodes 34a and 34b. The “Weapons Smuggling Event” is represented by an Event Node 36 that ties together two different ontologies 26. A plurality of dynamic ontological models graphically illustrating various instance data can be resident on an ontology server running an existing ontology editor such as Protégé. The ontologies can be created using the Web Ontology Language (OWL) or Resource Description Frameworks (RDF).

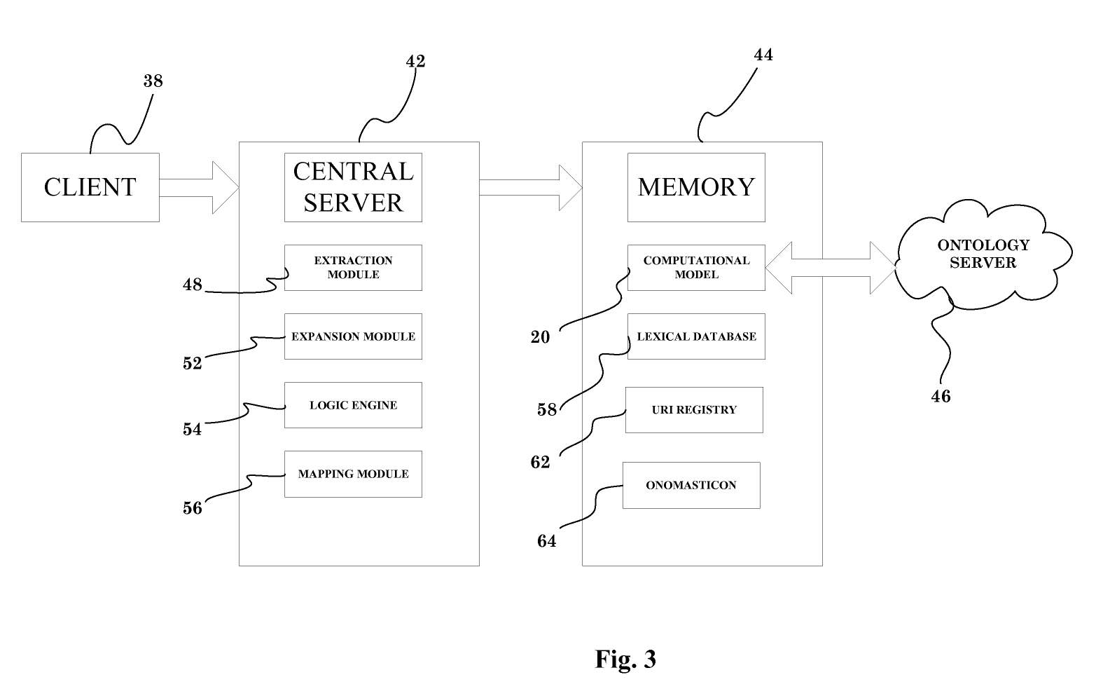

The disclosed system is described next in connection with FIG. 3. This figure illustrates a client 38 interfacing with a central server 42 and an associated memory 44. As explained below, central server 42 includes a series of modules that are used in extracting and expanding terms associated with the computational model 20. Client 38 can be a human user, or another server. As used herein, the term server refers to any of various types of computing devices, such as computer clusters, server pools, general-purpose personal computers, workstations, or laptops. Central server 42 communicates with ontology server 46 via memory 44 over a network.

The client may likewise communicate with the central server over a network. As used herein, the term network refers to wireless or wireline communication that can be carried out via any number of known protocols, including, but not limited to, Internet Protocol (IP), Wireless Access Protocol (WAP), Frame Relay, or Asynchronous Transfer Mode (ATM). Any other suitable protocols using voice, video, data, or combinations thereof, can also be employed. The network may include one or more local area networks (LANs), radio access networks (RANs), metropolitan area networks (MANS), wide area networks (WANs), and/or all or a portion of the global computer network known as the Internet, and/or any other communication system or systems at one or more locations.

The central server may include a series of one or more modules or logic engines, which may be in the form of programs or subroutines running on the central server. The embodiment disclosed in FIG. 3 includes an extraction module 48, an expansion module 52, a logic engine 54, and a mapping module 56. The extraction module 48 extracts terms associated with the input and output variables (22 and 24) of computational module 20.

The extracted terms are then sent to expansion module 52 where various semantic equivalents are determined. This is achieved by calling upon a lexical database 58 that groups nouns, verbs, adjectives, and adverbs into sets of cognitive synonyms. One suitable lexical database is WordNet,® which is run by Princeton University. Information regarding WordNet® can be found at http://wordnet.princeton.edu/ (last visited Dec. 27, 2010). Other currently available term expanders are suitable, such as the semantic reverse query expansion (SRQE) system from Raytheon Company (“Express Sense”). The lexical database 58 returns a series of candidate terms based upon the extracted terms submitted. Thereafter, expansion module 52 reviews the candidate terms and determines the appropriate word sense. For example, if the term “weapon” is returned by extraction module 48, lexical database 58 may return various candidate terms, such as “gun,” “bomb,” or “firearm.” Some of the candidate terms may have more than one word sense. For instance, expansion module 52 may have to differentiate “bomb” as used to describe an explosive bomb, from “bomb” as used to describe an event that fails badly. Candidate terms that do not match the appropriate word sense are discarded. Expansion module 52 can be used to further determine appropriate “nyms” for any semantically equivalent terms. Nyms include, but are not limited to, hypernyms, holonyms, hyponyms, meronyms, acronyms, synonyms, verb participles, triponyms, entailments, and coordinate terms. “Expanded terms” as used hereinafter includes terms returned by the lexical database and having the appropriate word sense, as well as any associated nyms.

The relevance of the expanded terms can be further verified via logic engine 54. This is accomplished by comparing the expanded terms to the remaining terms in computational model 20. By comparing the expanded terms to the terms associated with the other input and output variables (22 and 24), the validity of the expanded terms can be verified. Any expanded terms that do not logically fit with the remaining terms are discarded as invalid. Commercially available logic engines can be employed in this step.

The final module is a mapping module 56 that maps the expanded terms to the computational model 20 and variables (22 and 24) from which the expanded terms were obtained. More specifically, the validated semantic equivalents obtained from the logic engine 54 are linked to the input and output variables (22, 24) from the B-net 20 from which they were obtained. This mapping is carried out by way of the previously extracted URI data contained in the ontologies under evaluation, which is stored in URI registry 62 (note FIG. 3). As noted above, each computational model 20 and each variable (22 in FIG. 1; 32a, 32b in FIG. 2) associated therewith has a unique URI. The expanded term(s) in 22 are mapped to the key concept nodes. There is a separate URI for the B-Net. Mapping is done to node 32 by B-Net URI reference. This extracted URI data can be matched with corresponding expanded and validated terms. This, in turn, permits a listing of validated semantic equivalents to be recalled upon referencing one of the variables in the computational table. The semantic equivalents and associated mapping data can be stored in a database called an onomasticon 64. Onomasticon 64 can be stored in the memory of the central server as illustrated in FIG. 3 or it can be stored in a remote database accessible via a computer network.

The mapping information utilizes a binding of system choice (XML, RDF, RDFS, OWL Lite, OWL, Full OWL, KIF, DAML, OIL, DAML+OIL, etc). Mapping information for all term representation(s) stored include: 1) unique ID of the B-Net, and 2) unique ID of the variables in a CPT of a unique B-Net. The unique ID for a B-Net is obtained by extracting the URI of the B-Net contained in a registry. The unique ID for term(s) that represent variables in a CPT is obtained by extracting the URI of the term in a registry. Semantically equivalent terms contained in the onomasticon can be used by the B-Net and CPT when formulating queries or when mediating terms in a CPT, and an existing ontology model such as ontology 26 in FIG. 2.

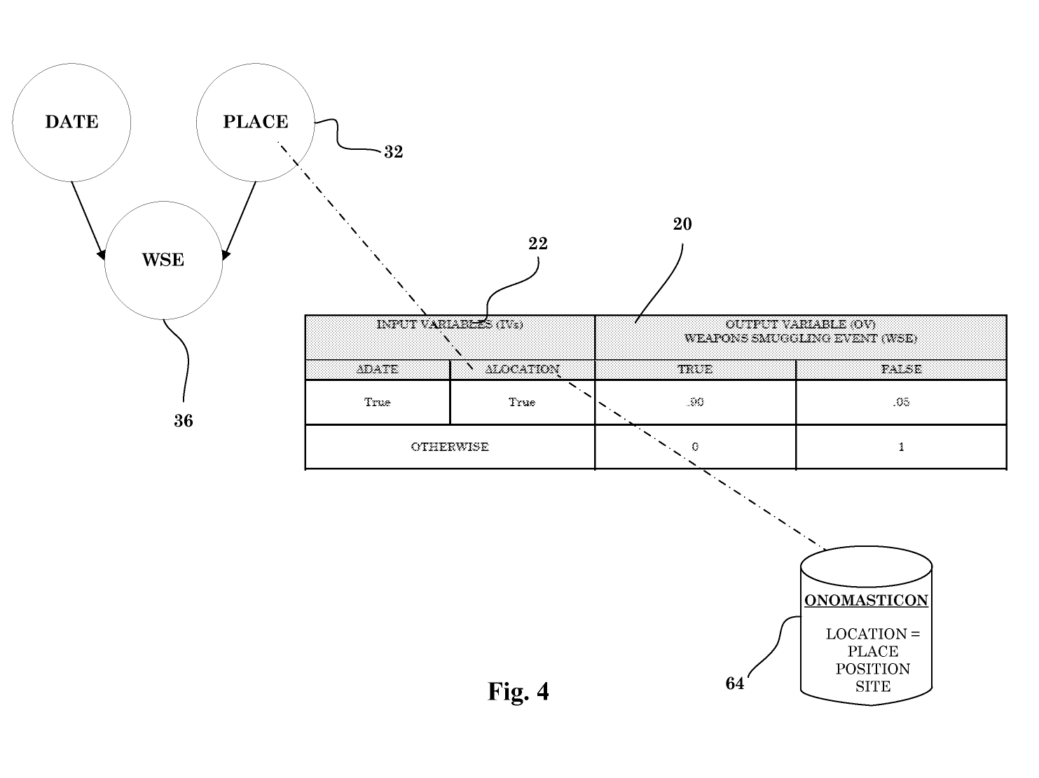

Referencing the data in onomasticon 64 permits expansion of both the input and the output variables (22 and 24) in the computational table. The input variables can be expanded in order to permit the input variables to be populated with semantically equivalent and logically relevant instance data from the ontological models 26. More specifically, if terms for the input variables 22 are known, equivalent terms from the key concept nodes 32 can be used as semantically equivalent Key Concept Nodes 32. This is illustrated in FIG. 4, wherein the input term 22 “Location” is expanded to “Place,” “Position,” and “Site.” Following this expansion, the data from the key concept node 32 “Place” can be used to populate the “ΔLocation.” Thus, without expanding the input terms 22, semantically equivalent and logically relevant instance data from ontologies 26 would go unused.

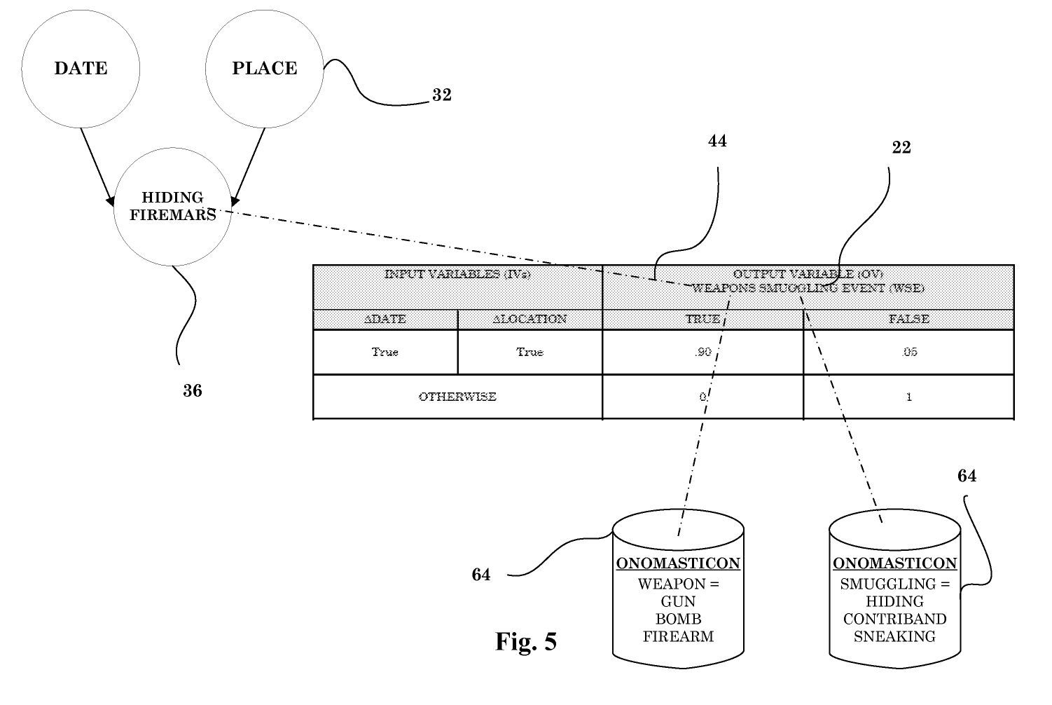

Likewise, expanding the terms associated with the output variable 24 permits output data to be more productively used. It also permits Key Concept Nodes 32 to be connected to semantically equivalent and logically relevant Event Nodes 36. For instance, in the example illustrated in FIG. 5, the output terms 24 “Weapon” has been expanded to include “Gun,” “Bomb,” and “Firearm.” Similarly, the output term 24 “Smuggling” has been expanded to include “Hiding,” “Contraband,” and “Sneaking.” Thus, the probabilities listed in the CPT for the existence of a “Smuggling Event” can be tied to additional events by way of the term expansion. The expansion also permits the Key Concept Nodes “Date” and “Place” to be tied to the semantically equivalent Event Node “Hiding Firearms.”

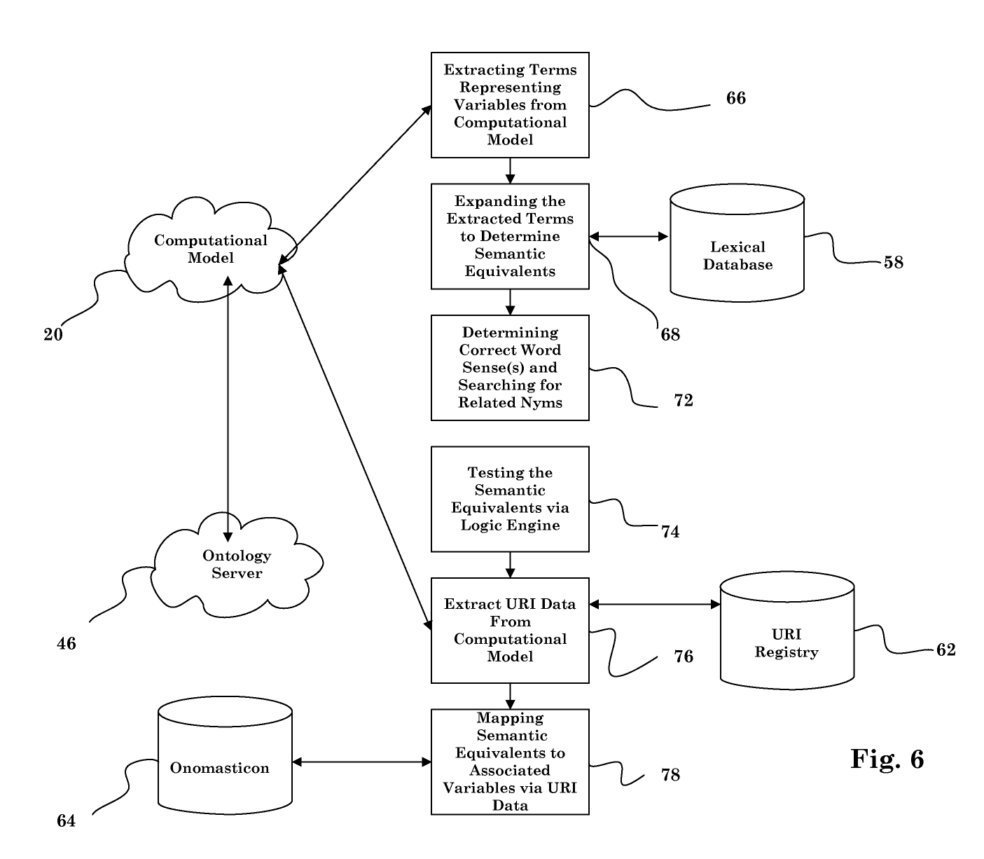

The method associated with the present invention is illustrated with reference to FIG. 6. In the first step 66, the terms associated with the variables are extracted from the Computational Model 20. In the next step 68, the extracted terms are expanded by referencing a Lexical Database 58 to determine any semantic equivalents. An optional step 72 may be used to determine the correct word sense for the extracted terms and also suitable nyms. Next, at step 74, the validity of the semantic equivalents is determined. This is achieved with reference to the conditional probability table contained in Computational model 20. Any invalid terms are discarded. Thereafter, at step 76, URI data associated with the computational model and variables is extracted. This URI data may be stored in a URI registry 62 for later reference (note FIG. 6). In the final step 78, the validated semantic equivalents are mapped to the corresponding variable and conditional probability table from which the variable was extracted. This mapping step is carried out with reference to the previously extracted URI data. Both the expanded terms and the mapping data are stored in an Onomasticon 64 for later reference. The disclosed method may optionally include the steps of storing a plurality of ontological models in an Ontology Server 46 and subsequently referencing the validated semantic equivalents and associated mapping information in the onomasticon for the purpose of populating the Input Variables 22 and Output Variables 24 of the computational model with semantically relevant instance data. The onomasticon can also be referenced to associate the output variable with one or more semantically relevant event nodes.

Alternative methodology to expand term(s) that represent input variables in a CPT includes the following steps: 1) Extract the term(s) representing an input variable(s) in a conditional probability table; 2) Take the extracted term(s) (for example “location”) and submit to a term expander to determine a word sense; 3) Determine word sense from senses returned; 4) obtain “nyms” if they exist for the term (nyms include hypernyms, holonyms, hyponyms, meronyms, verb participles, triponyms, entailments, and coordinate terms for the extracted terms; 5) Reason about nyms suitability as semantically equivalent term(s) to the input variable term(s); 6) Extract B-Net URI; 7) Extract input variable URI; and 8) Update onomasticon with verified terms and mapping information.

Alternative methodology to expand term(s) that represent output variables in a CPT includes the following steps: 1) Extract the term(s) representing an output variable(s) in a conditional probability table; 2) Take the extracted term(s) (for example “weapon”) and submit to a term expander to determine a word sense; 3) Determine word sense from senses returned; 4) obtain nyms if they exist for the term (i.e. nouns hypernyms, holonyms, hyponyms, meronyms, verb participles, triponyms, entailments, and coordinate terms); 5) reason about the nyms suitability as semantically equivalent term(s) to the output variable term(s); 6) extract B-Net URI; 7) extract output variable URI; 8) update onomasticon with verified terms and mapping information.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A method for expanding variables associated with a computational model, the variables including input and output variables that are related via a conditional probability table, the method comprising the following steps:
extracting a variable from the computational model;
expanding the extracted variable by determining semantic equivalents;
testing the validity of the semantic equivalents, the validity being determined by reference to the conditional probability table, and discarding any semantic equivalents determined to be invalid;
mapping the validated semantic equivalents to the corresponding variable and conditional probability table from which the variable was extracted;
storing the validated semantic equivalents and associated mapping information for future reference.

2. The method as described in claim 1 comprising the further steps of:
determining the correct word sense for the extracted variable by referencing the semantic equivalents.

3. The method as described in claim 1 comprising the further step of:
determining nyms for each of the semantic equivalents.

4. The method as described in claim 1 wherein universal resource indicator (URI) data are associated with the input and output variables and the computational model, wherein the method comprises the additional steps of:
extracting the URI data from the computational model; and
mapping the validated semantic equivalents to the corresponding variable and conditional probability table from which the variable was extracted by referencing the URI data.

5. The method as described in claim 1 further comprising the step of:
storing a plurality of ontological models in an ontology server, the ontological models graphically illustrating instance data as a series of interrelated concept and event nodes.

6. The method as described in claim 5 comprising the further steps of:
referencing the validated semantic equivalents and associated mapping information; and
populating the input variables of the computational model with semantically relevant instance data from the concepts nodes of the ontology server.

7. The method as described in claim 5 further comprising the steps of:
referencing the validated semantic equivalents and associated mapping information; and
associating the output variable with one or more semantically relevant event nodes.

8. The method as described in claim 1 wherein terms are associated with each of the variables and wherein the extraction step involves extracting the terms associated with the variables.

9. The method as described in claim 1 wherein the computational model is a Bayesian-network wherein the conditional probability table specifies the probability of an output variable in terms of the input variables.

10. The method as described in claim 1 wherein the expansion step is carried out by referencing a lexical database.

11. A system for expanding terms associated with a computational model, the expanded terms permitting the computational model to be populated with semantically relevant instance data, the system comprising:
an ontology server storing a plurality of ontological models graphically illustrating the instance data;
a Bayesian-network stored in a computer memory, the Bayesian-Network comprising a plurality of input variables, an output variable, and a conditional probability table specifying the probability of the output variable based upon the input variables, at least one term associated with each of the input variables, universal resource identifier (URI) data associated with the Bayesian-network and the input variables;
an extraction module for extracting terms associated with the input variables of the Bayesian-network;
an expansion module and a lexical database, the expansion module referencing the lexical database to determine semantic equivalents for each of the extracted terms;
a logic engine for testing the validity of the semantic equivalents, the validity being determined by reference to the output variable and other input variables of the Bayesian-network, the logic engine discarding any semantic equivalents determined to be invalid;
a mapping module for mapping the validated semantic equivalents to the input variable and Bayesian-network from which the extracted terms were obtained, the mapping module carrying out the mapping by way of the URI data;
an onomasticon for storing the validated semantic equivalents and associated mapping information, whereby reference to the onomasticon permits the input variables to be populated with semantically relevant instance data from the ontology server.

12. The system as described in claim 11 wherein the expansion module further determines the correct word sense from among all the semantic equivalents.

13. The system as described in claim 11 wherein the expansion module further locates relevant nyms for each of the semantic equivalents.

14. The system as described in claim 11 wherein the extraction, expansion, and mapping modules all reside on a common server along with the logic engine.

15. The system as described in claim 11 wherein the Bayesian-network, lexical database, onomasticon and URI Data are all stored in a common memory.

16. A system for expanding terms associated with a computational model, the expanded terms permitting the computational model to be associated with semantically relevant instance data, the system comprising:
an ontology server storing a plurality of ontological models graphically illustrating the instance data, each ontological model comprising one or more event nodes;
a Bayesian-network stored in a computer memory, the Bayesian-Network comprising a plurality of input variables, an output variable, and a conditional probability table specifying the probability of the output variable based upon the input variables, at least one term associated with the output variable, universal resource identifier (URI) data associated with the Bayesian-network and the output variable;
an extraction module for extracting terms associated with the output variable of the Bayesian-network;
an expansion module and a lexical database, the expansion module referencing the lexical database to determine semantic equivalents for each of the extracted terms;
a logic engine for testing the validity of the semantic equivalents, the validity being determined by reference to input variables of the Bayesian-network, the logic engine discarding any semantic equivalents determined to be invalid;
a mapping module for mapping the validated semantic equivalents to the output variable and Bayesian-network from which the extracted terms were obtained, the mapping module carrying out the mapping by way of the URI data;
an onomasticon for storing the validated semantic equivalents and associated mapping information, whereby reference to the onomasticon permits the output variable to be associated with one or more semantically relevant event nodes.

17. The system as described in claim 11 wherein the expansion module further determines the correct word sense from among all the semantic equivalents.

18. The system as described in claim 11 wherein the expansion module further locates relevant nyms for each of the semantic equivalents.

19. The system as described in claim 11 wherein the extraction, expansion, and mapping modules all reside on a common server along with the logic engine.

20. The system as described in claim 11 wherein the Bayesian-network, lexical database, onomasticon and URI Data are all stored in a common memory.
